(19) United States
(12) Patent Application Publication
(10) Pub. No.: US 2006/0018627 A1
(43) Pub. Date: Jan. 26, 2006

(54) Image reproducing apparatus and image reproducing method

(75) Inventor: Yasushi Kasai, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/182,005

(22) Filed: Jul. 15, 2005

(30) Foreign Application Priority Data
Jul. 20, 2004 (JP) 2004-212019

(51) Int. Cl. H04N 5/781

(52) U.S. Cl. 386/46; 386/125

(57) ABSTRACT

An image reproduction apparatus for recording reproduction history information for distinguishing a reproduced image and an unreproduced image in a removable memory, and for giving, by referring to the reproduction history information, a priority to an unreproduced image in reproducing images in an unreproduced image prioritized reproduction mode.

### BACKGROUND OF THE INVENTION

1. Field of the Invention

The present invention relates to a technology for reproducing an image, such as a moving image or a still image, recorded on a recording medium.

2. Related Background Art

Certain image reproducing apparatus such as a digital camera or a digital video camcorder can record and reproduce both a still image and a moving image on a removable medium. Also there is known an image reproducing apparatus which, in a reproducing mode, is capable of automatically reproducing a still image or a moving image recorded (photographed) most recently even when the user does not particularly designate an image to be reproduced.

Also for reviewing still images recorded in the recording medium of such image reproducing apparatus, there is known a method of displaying one image on a display screen, and changing over, by a switching operation, the displayed image sequentially in a forward order or in a backward order. There are also known a method of displaying plural images at the same time on a display screen (index display) and a method of displaying the recorded images with being switched in succession (slide show display) (cf. Japanese Patent Application Laid-open No. 2003-339012).

With a recent increase in the capacity of the removable memory, still image files or moving image files of a large amount can be recorded on the recording medium of the image reproducing apparatus. In case of reproducing the images from such recording medium, it is difficult to reproduce a group of recently-recorded still image files or moving image files.

For example, a slide show function is executed on all the still image files or the moving image files recorded in the removable memory, and displays all the still image data in succession. It is therefore difficult to selectively browse only the recently-recorded still image files or the moving image files.

Also in the prior image reproducing apparatus, there is not available a function of extracting and promptly reproducing only an unreproduced still image file or a moving image file.

### SUMMARY OF THE INVENTION

The present invention has been made to solve such drawback, and an object of the present invention is to provide an image reproducing apparatus and an image reproducing method capable of selectively reproducing, from among the recorded images, an unreproduced image by a simple operation.

According to the present invention, such object can be attained by an image reproducing apparatus for reproducing images recorded in a removable memory with file names provided in accordance with a certain naming rule relating to the order of recording, including a history recording unit for recording, in the removable memory, reproduction history information for distinguishing a reproduced image and an unreproduced image in accordance with the reproduction of the images recorded in the removable memory, and a reproduction unit for giving priority to an unreproduced image in reproducing images in an unreproduced image priority reproduction mode, by referring to the reproduction history information.

The present invention will be clarified by a following detailed description which is to be taken in conjunction with the accompanying drawings.

### BRIEF DESCRIPTION OF THE DRAWINGS

FIG. 1 is a block diagram showing a schematic configuration of an image reproducing apparatus of the present invention;

FIG. 2 is a view showing an example of structure of a directory, a file and a temporary file recorded in a memory 6;

FIG. 3 is a view showing an example of structure in the temporary file;

FIG. 4 is a first view showing a setting screen for setting a prioritized reproduction of an unreproduced image;

FIG. 5 is a second view showing a setting screen for setting a prioritized reproduction of an unreproduced image;

FIG. 6 is a third view showing a setting screen for setting a prioritized reproduction of an unreproduced image;

FIG. 7 is a fourth view showing a setting screen for setting a prioritized reproduction of an unreproduced image;

FIG. 8 is a flow chart showing a reproducing sequence of a first embodiment after the apparatus is activated;

FIG. 9 is a flow chart showing a reproducing sequence of an image forward reproduction in the first embodiment;

FIG. 10 is a fifth view showing a setting screen for setting a prioritized reproduction of an unreproduced image; and

FIG. 11 is an operation flow chart of an image recording mode of a second embodiment.

### DETAILED DESCRIPTION OF THE PREFERRED EMBODIMENTS

In the following, embodiments of the present invention will be explained in detail with reference to the accompanying drawings.

### First Embodiment

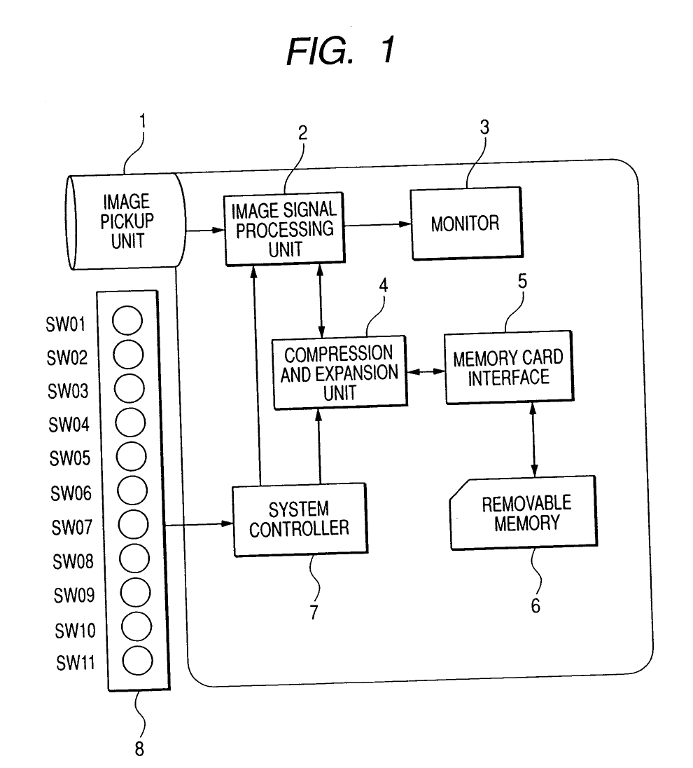

FIG. 1 is a block diagram schematically showing a configuration of an image reproducing apparatus of the invention, wherein shown are an image pickup unit 1 for converting an object into an image signal, an image signal processing unit 2, a monitor 3 for displaying the image signal processed by the image signal processing unit 2, a compression/expansion unit 4 for a still image or a moving image, and an interface 5 with a memory card 6, which is a removable memory capable of recording an image as a file.

There are also provided a system controller 7 for controlling the entire system, and operation switches to be operated by a user. The operation switches 8 include a photo switch SW01, a menu switch SW02, a switch SW03 for selecting menu items in an upward direction, a switch SW04 for selecting menu items in a downward direction, and a switch SW05 for determining a selected item.

There are further provided a mode switch SW06 for activating a reproduction mode, an image pickup mode switch SW07 for activating an image pickup mode, a forward switch SW08 for executing sequential image reproduction in the forward direction by a manual operation, and a backward switch SW09 for executing sequential image reproduction in the backward direction by a manual operation.

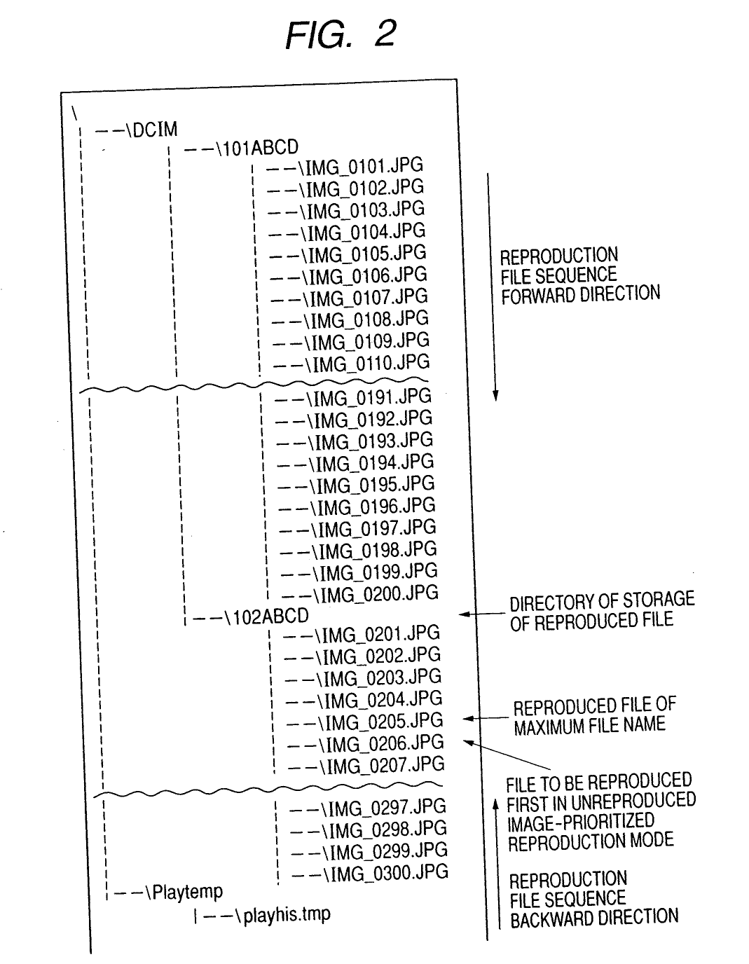

FIG. 2 shows an example of configuration of files recorded in the removable memory 6. Numbers attached to a directory title and a file title increase in the order of image pickup. Arrows indicate a case of advancing the file sequence in an order of image pickup and a case of advancing the file sequence in an opposite order. A temporary file for recording the reproduced files is stored in an independent directory “playtemp” in the removable memory 6.

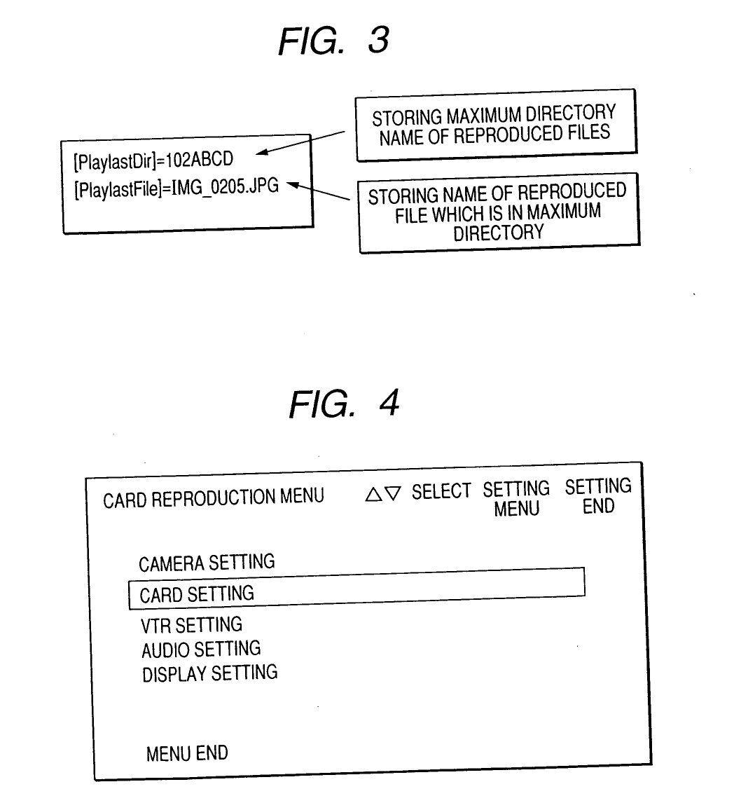

FIG. 3 shows an internal structure of a file “playhis. tmp” in the directory “playtemp”. In the example shown in FIG. 3, it is indicated that image files after a file “IMG_{—}0205.JPGW in a directory 102ABCD” are unreproduced image files.

In the following, there will be explained a setting method for a mode of prioritized reproduction of an unreproduced image file (still image file or moving image file) in the present embodiment.

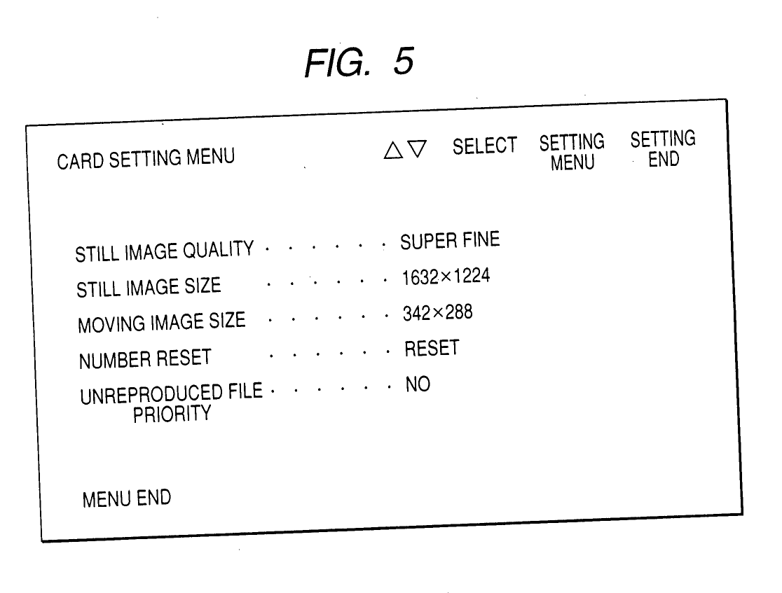

When the menu switch SW02 is depressed, a menu screen shown in FIG. 4 is displayed on the monitor 3. Then the switches SW03, SW04 are operated to select a menu item “card setting”, and the selected item determining switch SW05 is depressed, whereby an image shown in FIG. 5 is displayed on the monitor 3.

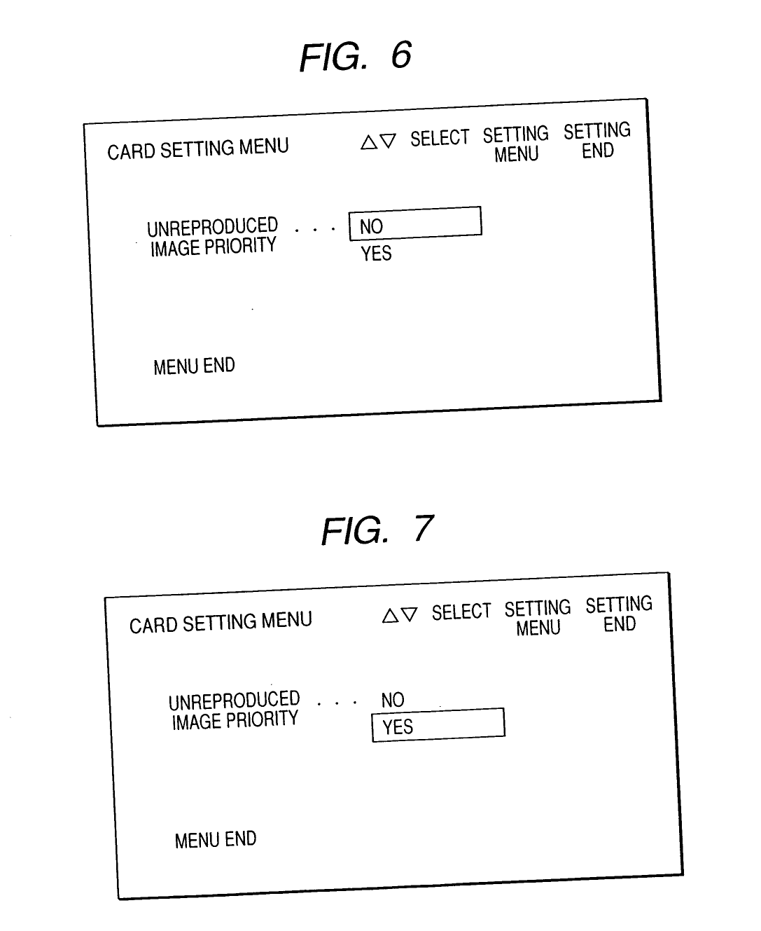

While the image shown in FIG. 5 is displayed, the switches SW03, SW04 are operated to select “prioritized reproduction of unreproduced images” and the selected item determining switch SW05 is depressed, whereby an image shown in FIG. 6 is displayed on the monitor 3. In this state, an item “YES” is selected by the switches SW03, SW04 and the menu switch is depressed again, whereby the unreproduced image prioritized reproduction” mode is designated.

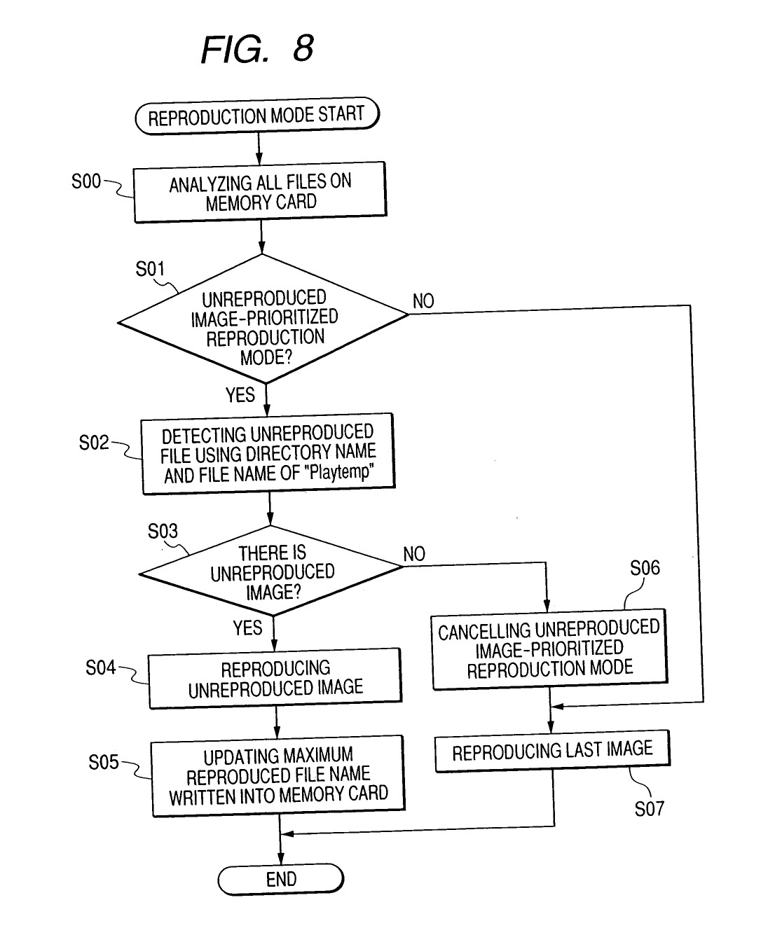

FIG. 8 is a flow chart of a reproducing operation when the power supply is turned on in a reproduction mode selected by depressing the reproduction mode switch SW06.

When the power supply is turned on in the reproduction mode, in a step S00, the system controller 7 analyzes the content of the removable memory 6 and recognizes directories and image files.

In a step S01, the system controller 7 discriminates whether a mode for prioritized reproduction of the unreproduced image is designated. Information on the reproduction mode is stored in an internal memory of the system controller 7 even when the power supply is turned off.

In case an unreproduced image prioritized reproduction mode is designated, the system controller 7 compares in a step S02 maximum names of an already reproduced directory and an already reproduced file recorded in “playhis. tmp” of the removable memory 6 with the result of analysis in the step S00. In this comparison, a file recorded after the maximum directory name and the maximum file name in “playhis. tmp” is detected as an unreproduced still or moving image file.

In a step S03, the system controller 7 discriminates whether an unreproduced image file has been detected.

In a step S04, the system controller 7 reproduces an image file of an earliest file name from among the unreproduced image files. In the example shown in FIG. 2, since the maximum file name in “playhis. tmp” is “IMG_{—}205. JPG”, a reproduction is executed on “IMG_{—}206. JPG”.

In a step S05, the maximum directory name and the maximum file name of the reproduced files in “playhis. tmp” are updated for the files reproduced in the unreproduced image prioritized reproduction mode. In the example shown in FIG. 2, a maximum file name “IMG_{—}206. JPG” is recorded in “playhis. tmp”.

Even in the unreproduced image prioritized reproduction mode, in case the step S03 discriminates absence of an unreproduced file, a step S06 cancels the unreproduced image prioritized reproduction mode.

Also in case the step S01 discriminates that the unreproduced image prioritized reproduction mode is not designated, the system controller 7 executes, in a step S207, a last image file (“IMG_{—}300. JPG”).

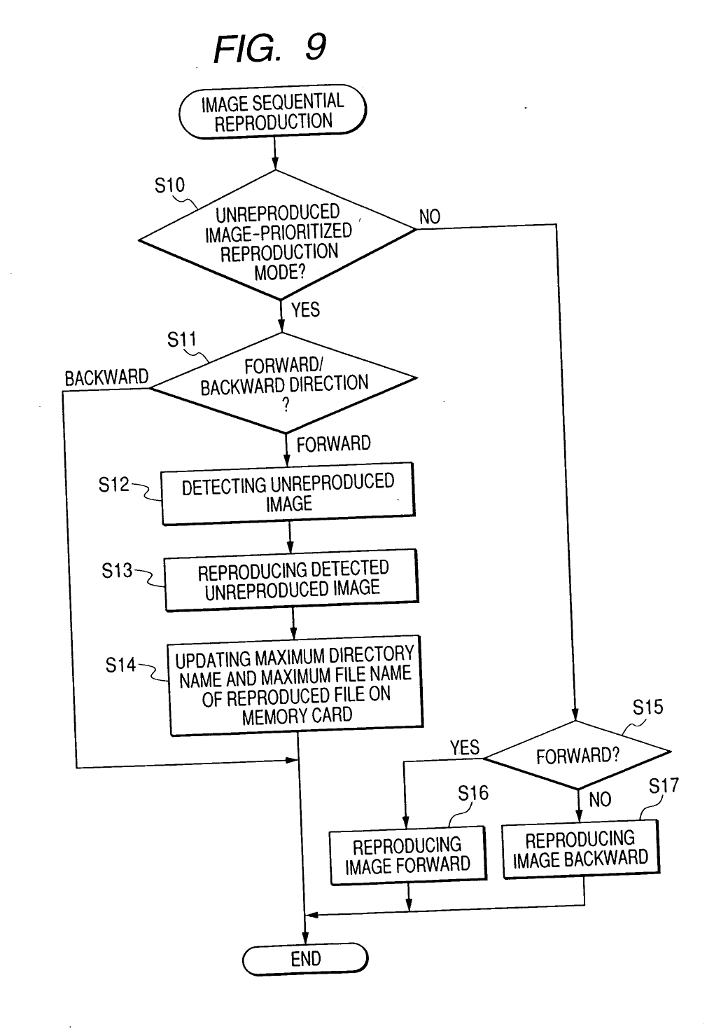

FIG. 9 is a flow chart of a image sequential reproduction in the unreproduced image prioritized reproduction mode.

Such image sequential reproduction can be executed when an image pickup mode is switched to a reproduction mode by an operation of the switch SW06. The images can be sequentially switched one by one manually by the switch SW08 or SW09. Also an automatic sequential reproduction is possible by designating a slide show reproduction mode. The slide show reproduction can be executed by operating the menu switch SW02 in the reproduction mode to display a setting screen and by entering an instruction with the switch SW05 on such setting screen.

In a step S10, the system controller 7 confirms whether the unreproduced image prioritized reproduction mode is designated. Then in a step S11, the system controller 7 judges whether the sequence of images is in the forward direction or in the backward direction. No action is executed in case of a switch input for the backward direction.

In a step S12, the system controller 7 detects an unreproduced image in the forward direction. A file analysis in the step S00 in FIG. 8 is assumed to be executed in advance at a start-up of the apparatus or a shift to the reproduction mode.

In the example shown in FIG. 2, in response to the depression of the forward direction switch SW08, files are compared in succession from “IMG_{—}0101. JPG” with the content of “playhis. tmp”, and image files starting from “IMG_{—}0206. JPG” succeeding to the “IMG_{—}0205. JPG” which coincides with the file name in “playhis. tmp” are detected as unreproduced image files.

In a step S13, the system controller reproduces thus detected unreproduced image file “IMG_{—}0206. JPG”, and, in case of a slide show display mode, also sequentially reproduces the ensuing image files.

In a step S14, the system controller 7 updates the maximum reproduced file name in “playhis. tmp” to “IMG_{—}0206. JPG”. In case of a slide show display mode, it is updated to a last image file name in such slide show display.

In case the step S10 discriminates that the unreproduced image prioritized reproduction mode is not designated, a step S15 discriminates whether the sequence of images is in the forward direction or in the backward direction.

Then a step S16 reproduces the files in a forward sequence in the ordinary reproduction mode. In the present example, the reproduction is made in the forward direction from “IMG_{—}0101. JPG”.

Also a step S17 reproduces the files in a backward sequence in the ordinary reproduction mode. In the present example, the reproduction is made in the backward direction from “IMG_{—}0300. JPG”.

In case the step S16 also reproduces the unreproduced image files, in order to achieve a matching with the unreproduced image prioritized reproduction mode, the updating process of the step S14 may be executed after the step S16.

As explained in the foregoing, the present embodiment executes an analysis of unreproduced image files and allows to select a reproduction of the unreproduced image files only or a prior reproduction of all the image files, thereby enabling to promptly reproduce the unreproduced image files only.

### Second Embodiment

In the above-described first embodiment, in the unreproduced image prioritized reproduction mode, all the unreproduced images are preferentially reproduced in an order from an oldest image.

However, while certain users wish to preferentially reproduce all the unreproduced image files, other certain users wish to preferentially reproduce unreproduced image files within more recent files. The definition of the term “recent” is variable depending on the taste or purpose of the users.

The present embodiment allows, for each user, to define a range of the image files that can be preferentially reproduced, and to update the history information in each image pickup operation.

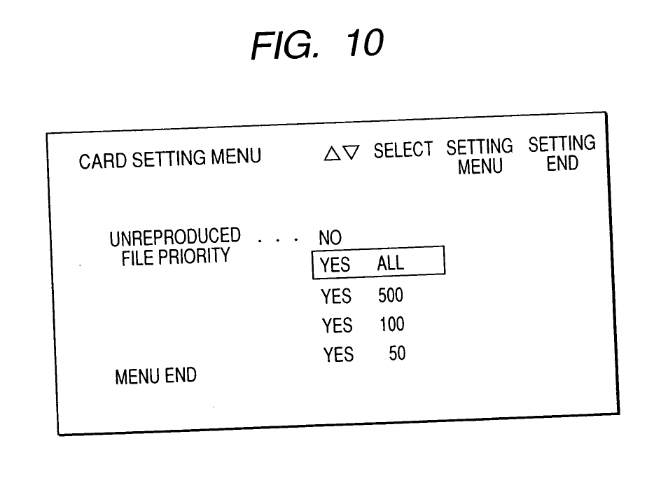

FIG. 10 shows details of a setting screen for the unreproduced image prioritized reproduction mode of the present embodiment. In selecting the unreproduced image prioritized reproduction mode, it is possible to designate, for the prioritized reproduction, all the files, 500 images from the latest image, 100 images from the latest image, or 50 images from the latest image.

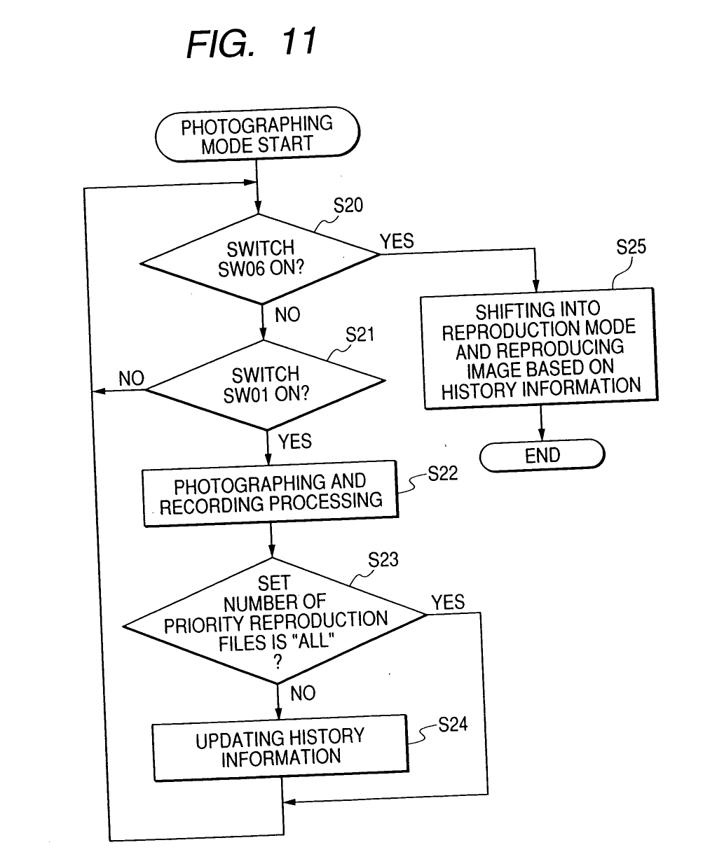

FIG. 11 is a flow chart showing an update process for the history file “playhis. tmp” in the image pickup mode.

At first, after a shift to the image pickup mode by the switch SW07, the system controller 7 monitor, in a step S20, a shift to a reproduction mode by a depression of the switch SW06. Also in a step S21, it monitors whether an image pickup is instructed by a depression of the switch SW01.

In case the step S21 discriminates a depression of the switch SW01, the system controller 7 controls the image pickup operation by the image pickup unit 1 and a process of recording the obtained image onto the removable medium 6 (S22). Also it names the newly recorded file as “IMG_{—}0301. JPG” which is added to the file management information shown in FIG. 2.

Then, in a step S23, the system controller 7 discriminates, in the detailed setting screen shown in FIG. 10, whether “all” the files are designated. In case “all” the files are not designated but a specific number of files is designated, the history file “playhis. tmp” is updated.

For example, in case a file number “50” is designated in FIG. 10, a file name is updated to “IMG_{—}0251. JPG” which precedes “IMG_{—}0301. JPG” by 50 files.

Also in case the step S23 discriminates that “all” the files are designated, “playhis. tmp” is not updated.

After the above-described update process, in case the switch SW01 is operated (step S21), an update process is executed again to write “IMG_{—}0252. JPG” into the “playhis. tmp”.

In case the step S20 discriminates a depression of the switch SW06, the system controller 7 shifts the operation mode to a reproduction mode (step S25). In case the history is updated in the step S24, the reproduction is executed from a file (IMG_{—}252. JPG, IMG_{—}0253. JPG etc.) next to the file written by such update process. Details of the reproduction in the reproduction mode are same as in the first embodiment, and the history information is updated for each file reproduction in the 50 files.

Also in case the update process is not executed in the image pickup mode, namely in case the image pickup is executed in a state where “all” is set in FIG. 10, the reproduction is executed according to the history information prior to the shift to the image pickup mode. Thus a reproduction is executed from “IMG_{—}0206. JPG” explained in the first embodiment.

In the present embodiment, as explained in the foregoing, it is possible to designate a number of files to be preferentially reproduced according to the taste or purpose of the user, and the reproduction based on the reproduction history can be executed within such designation range.

Also since the history information is automatically updated at the new image recording by the image pickup operation, the user can reproduce the recently recorded image always within a designated range without being required to execute an additional operation.

The present invention has been explained by preferred embodiments, but the invention is not limited to the aforementioned embodiments and subject to various modifications within the scope and spirit of the appended claims.

The object of the present invention can also be achieved by providing a storage medium storing program codes for performing the aforesaid processes to an image reproducing-apparatus, reading the program codes by a CPU or an MPU of the image reproduction apparatus, from the storage medium, then executing the program.

In this case, the program codes read from the storage medium realize the functions according to the embodiments, and the storage medium storing the program codes constitutes the invention.

Further, the storage medium, such as a floppy disk, a hard disk, an optical disk, a magneto-optical dis, CD-ROM, CD-R, a magnetic tape, a non-volatile type memory card, and ROM, and computer network, such as LAN (local area network) and WAN (wide area network), can be used for providing the program codes.

Furthermore, besides aforesaid functions according to the above embodiments are realized by executing the program codes which are read by a CPU of the image reproduction apparatus, the present invention includes a case where an OS (operating system) or the like working on the computer performs a part or entire processes in accordance with designations of the program codes and realizes functions according to the above embodiments.

Furthermore, the present invention also includes a case where, after the program codes read from the storage medium are written in a function expansion card which is inserted into the image reproduction apparatus or in a memory provided in a function expansion unit which is connected to the image reproduction apparatus, CPU or the like contained in the function expansion card or unit performs a part or entire process in accordance with designations of the program codes and realizes functions of the above embodiments.

In a case where the present invention is applied to the aforesaid storage medium, the storage medium stores program codes corresponding to the flow charts of FIGS. 8 and 9 or FIG. 11 described in the embodiments.

This application claims priority from Japanese Patent Application No. 2004-212019 filed on Jul. 20, 2004, which is hereby incorporated by reference herein.

What is claimed is:

1. An image reproduction apparatus for reproducing images recorded in a removable memory with file names according to a predetermined naming rule relating to the order of recording, comprising:
a history recording unit for recording, in the removable memory, reproduction history information for distinguishing a reproduced image and an unreproduced image in accordance with the reproduction of the images recorded in the removable memory; and
a reproduction unit for giving priority to an unreproduced image in reproducing images in an unreproduced image prioritized reproduction mode, by referring to the reproduction history information.

2. An image reproduction apparatus according to claim 1, wherein the reproduction unit automatically reproduces the unreproduced images in a time-sequentially forward direction.

3. An image reproduction apparatus according to claim 1, wherein the removable memory includes a semiconductor memory.

4. An image reproduction apparatus according to claim 1, further comprising:
a selection unit for selecting, at an activation of the apparatus, whether or not to execute the unreproduced image prioritized reproduction mode.

5. An image reproduction apparatus according to claim 4, wherein, in the absence of an unreproduced image, the apparatus shifts to an ordinary reproduction mode in which all the images recorded in the removable memory are reproduced.

6. An image reproduction apparatus according to claim 1, wherein:
the predetermined naming rule is a rule to attach continuous numbers in the order of recording into the removable memory; and
the reproduction history is a name of an image file which is given a largest number among the already reproduced image file and a name of a directory storing such file.

7. An image reproduction apparatus according to claim 1, further comprising a designation unit for designating a number of files to be covered by the reproduction history information.

8. An image reproduction apparatus according to claim 7, further comprising an update unit which, in case an image is newly obtained in an image pickup mode, updates the reproduction history information based on the designated number of files.

9. An image reproduction method for reproducing images recorded in a removable memory with file names according to a predetermined naming rule relating to the order of recording, comprising:
a history recording step of recording, in the removable memory, reproduction history information for distinguishing a reproduced image and an unreproduced image in accordance with the reproduction of the images recorded in the removable memory; and
a reproduction step of giving priority to an unreproduced image in reproducing images in an unreproduced image prioritized reproduction mode, by referring to the reproduction history information.

10. A recording medium which computer-readably records program codes for causing an image reproducing apparatus to execute the image reproduction method set out in claim 9.
